(19) United States
(12) Patent Application Publication
(10) Pub. No.: US 2009/0326947 A1
(43) Pub. Date: Dec. 31, 2009

(54) SYSTEM AND METHOD FOR SPOKEN TOPIC OR CRITERION RECOGNITION IN DIGITAL MEDIA AND CONTEXTUAL ADVERTISING

(76) Inventors: James Arnold, Helena, MT (US); P. Grant Carter, San Francisco, CA (US)

Correspondence Address: PERKINS COIE LLP, P.O. BOX 1208, SEATTLE, WA, 98111-1208, US

(21) Appl. No.: 12/492,707

(22) Filed: Jun. 26, 2009

Related U.S. Application Data
(60) Provisional application No. 61/076,458, filed on Jun. 27, 2008.

(51) Int. Cl. G10L 15/18; G10L 15/00; G10L 15/28; G06F 17/30

(52) U.S. Cl. 704/257; 704/231; 704/255; 707/5; 707/E17.044; 707/E17.109; 707/104.1; 704/E15.001

(57) ABSTRACT

Systems and methods for automated analysis and targeting of digital media based upon spoken topic or criterion recognition of the digital media are provided. Pre-specified criteria are used as the starting point for a top-down topic or criterion recognition approach. Individual words used in the audio track of the digital media are recognized only in context of each candidate topic or criterion hypothesis, thus yielding greater accuracy than two-step approaches that first transcribe speech and then recognize topic based upon the transcription.

### CROSS-REFERENCE TO RELATED APPLICATIONS

This application claims priority to U.S. Provisional Patent Application No. 61/076,458 filed Jun. 27, 2008, which is hereby incorporated by reference in its entirety.

### TECHNICAL FIELD

The present invention relates to applications based upon spoken topic understanding in digital media.

### BACKGROUND

Video is the fastest growing content type on the Internet. As with previous Internet content classes, including text and images, the video publishing business model centers on advertising revenue. Advertisers generally seek audiences with particular interests and/or demographic makeup to maximize the benefit of their advertising investment. Personalized advertisements are possible by tracking and analyzing the content that consumers view.

Because understanding a video and its contents reveals information about the video's viewers, one well-known approach to this involves automated text analysis of a site's web pages to identify its topics, and by inference, the apparent interests of its viewers. Extending this approach to video, however, has proven difficult in that automated topic recognition remains technically challenging on rich media, and at best, highly unreliable. Moreover, current methods of automatic speech recognition require substantial computing resources. Consequently, publishers can only offer site or section placement to their advertising customers, thus leading to lower advertisement pricing and revenues. Alternatively, the publisher may invest in extensive manual annotation of each video, although this process can be costly and lead to lower net profit margins associated with such advertising. As a consequence of this high cost, contextual advertising on so-called “long-tail” videos—the multitudes of Internet videos that produce small yet in aggregate valuable audiences—remains infeasible.

### SUMMARY

This Summary is provided to introduce a selection of concepts in a simplified form that are further described below in the Detailed Description. This Summary is not intended to identify key features or essential features of the claimed subject matter, nor is it intended to be used to limit the scope of the claimed subject matter.

Systems and methods for digital media contextual advertising and other types of services are described below. Advertiser placement criteria, such as topics, names of products, people, places, targeted demographics, and targeted viewer intent, are transformed into concept and/or sentiment recognition models that can be applied against audio tracks associated with digital media. The process does not determine specific words or word sequences but rather uses a speech algorithm to produce a time-sampled probability function for search words or phrases, thus consolidating speech and topic recognition. The approach applies one or more statistical classification models to intermediate outputs of a phonetic speech recognizer to predict the relevancy of the content of the digital media to targeted categories and viewer interests that may be used effectively for any application of spoken topic understanding, such as advertising.

### BRIEF DESCRIPTION OF THE DRAWINGS

Examples of a digital media contextual advertising system and method are illustrated in the figures. The examples and figures are illustrative rather than limiting. The digital media contextual advertising system and method are limited only by the claims.

FIG. 1A depicts a flow diagram illustrating an example process of generating a statistical classification model, according to one embodiment.

FIG. 1B depicts a flow diagram illustrating an example process of applying a statistical classification model to digital media, according to one embodiment.

FIG. 2 depicts a block diagram illustrating a generic application system for spoken criterion recognition of online digital media.

FIG. 3 depicts a block diagram illustrating an example online digital media and advertising system employing a contextual advertising for digital media application, according to one embodiment.

FIG. 4 depicts a block diagram illustrating a system for automated call monitoring and analytics, according to one embodiment.

FIG. 5 depicts a conceptual illustration of word and/or phrase-based topic and/or criterion categorization, according to one embodiment.

FIG. 6 depicts confidence score sequences for three example search terms, according to one embodiment.

### DETAILED DESCRIPTION

The following description and drawings are illustrative and are not to be construed as limiting. Numerous specific details are described to provide a thorough understanding of the disclosure. However, in certain instances, well-known or conventional details are not described in order to avoid obscuring the description. References to one or an embodiment in the present disclosure can be, but not necessarily are, references to the same embodiment; and, such references mean at least one of the embodiments.

Reference in this specification to “one embodiment” or “an embodiment” means that a particular feature, structure, or characteristic described in connection with the embodiment is included in at least one embodiment of the disclosure. The appearances of the phrase “in one embodiment” in various places in the specification are not necessarily all referring to the same embodiment, nor are separate or alternative embodiments mutually exclusive of other embodiments. Moreover, various features are described which may be exhibited by some embodiments and not by others. Similarly, various requirements are described which may be requirements for some embodiments but not other embodiments.

The terms used in this specification generally have their ordinary meanings in the art, within the context of the disclosure, and in the specific context where each term is used. Certain terms that are used to describe the disclosure are discussed below, or elsewhere in the specification, to provide additional guidance to the practitioner regarding the description of the disclosure. For convenience, certain terms may be highlighted, for example using italics and/or quotation marks. The use of highlighting has no influence on the scope and meaning of a term; the scope and meaning of a term is the same, in the same context, whether or not it is highlighted. It will be appreciated that the same thing can be said in more than one way.

Consequently, alternative language and synonyms may be used for any one or more of the terms discussed herein, nor is any special significance to be placed upon whether or not a term is elaborated or discussed herein. Synonyms for certain terms are provided. A recital of one or more synonyms does not exclude the use of other synonyms. The use of examples anywhere in this specification including examples of any terms discussed herein is illustrative only, and is not intended to further limit the scope and meaning of the disclosure or of any exemplified term. Likewise, the disclosure is not limited to various embodiments given in this specification.

Without intent to further limit the scope of the disclosure, examples of instruments, apparatus, methods and their related results according to the embodiments of the present disclosure are given below. Note that titles or subtitles may be used in the examples for convenience of a reader, which in no way should limit the scope of the disclosure. Unless otherwise defined, all technical and scientific terms used herein have the same meaning as commonly understood by one of ordinary skill in the art to which this disclosure pertains.

Extracting Information from Digital Media—Concept Analysis

While television networks may reach a massive audience in a single broadcast, information about its audience is only knowable within coarse aggregate statistics. In contrast, because individuals control their on-line video or digital media consumption, the ability to understand a video and its contents translates into information about its viewers, including viewers' interests, buying status, and through inference over time, demographic information. Consequently, on-demand Internet digital media presents opportunities for personalized advertisements that were not possible with broadcast media.

An evolution in on-line advertising sophistication has occurred over the past fifteen years, beginning from initial ‘run-of-site’ ad banner blanketing campaigns, and now to personalized ads selected based on a consumer's identification and activities. Automating delivery of personalized ads is made possible by tracking and analyzing the content that consumers view and the behavior they exhibit on and across websites, such as downloading or uploading certain types of content. However, this approach is difficult to extend to digital media content like videos and podcasts because computers have a limited ability to interpret speech and visual inputs, and metadata describing digital media is often inadequate. Given the vast scale of the Internet, it would be beneficial to automate the process of understanding digital media to facilitate personalization of advertisements associated with them.

Unfortunately, such solutions have proven elusive because machines remain unreliable at understanding inputs analogous to the human senses of hearing and sight, particularly when interpreting the nuanced human-human communications common to popular media. Machines do not yet bring the necessary sense of context, such as the setting, speaker status, base facts, common sense, or certainly sense of humor, that humans subconsciously apply to great success.

Both humans and computers must decode speech from a continuum of sound, rapidly selecting and revising candidate interpretations by balancing what a group of syllables may sound like against what is expected from context. This works well when a conversation contains few surprises. However, expected words are often detected when not uttered, and unexpected words may be missed when the direction of a conversation changes. While humans bring a remarkable ability to recognize and adapt to rapid context switches from a combination of nonverbal cues and common sense, computer speech recognition systems do not have this ability.

To compensate for their inability to detect context, computer speech systems limit their operation to carefully tuned topic areas of discourse, sometimes referred to as domains. Narrow domains perform best because lower language perplexities lead to fewer mistakes. This is why, for example, automated voice customer service systems, such as those employed by airlines and stock brokers, carefully guide the interaction to restrict the types of spoken responses (“say yes or no”, “speak your account number”). Narrow domains can lead to high error rates, however, when speakers step outside the domain and introduce vocabulary and grammatical structures not incorporated in the computer's language model. For example, current state of the art speech recognition technology yields word accuracy rates on the order of 20% when applied to a realistic mix of consumer-generated and professional entertainment media with a priori unknown domains.

In addition to, or as an alternative to, operating on narrow domains, some systems rely on speaker dependence to achieve acceptable speech recognition accuracies. Such systems require the end user to assist the system in understanding their voice through supervised or semi-supervised training. The process typically involves reading of text known to the system, as commonly found in commercial transcription products. Recognition accuracies as high as 95% have been reported with articulate speakers instrumented with professional-grade microphones, such as in some broadcast news applications. This solution, however, only applies when the speaker is known in advance, and thus not applicable to general on-line media.

These limitations lead to practical consequences for commercial applications. First, there is the paradox that automated speech recognition achieves useful accuracy only within a known, narrow context, and/or a known speaker. As a result, automated speech recognition is a poor choice for determining context, such as might support contextually targeted advertising.

Second, following from a main tenet of information theory, the greatest source of information resides in the least predictable words. However, conventional speech recognition systems are trained to identify common word sequences. Their design objective is to minimize the average word error rate, even though this reduces their ability to recognize rare terms (the system discounts these errors, as infrequent terms contribute minimally to word accuracy performance). Proper names are the most common words that are not accurately identified by conventional speech recognition systems including, but not limited to, names of people, companies, products, places, and events. These types of references are essential to many topic or criterion recognition tasks, especially targeted advertising.

In addition, modem, high-accuracy speech recognizers require substantial computing resources. A typical large vocabulary transcription system requires a dedicated processor core and on the order of 1 GB RAM per voice channel to achieve real-time throughput.

In summary, although progress has been made in commercial application of interactive speech systems within limited domains, such as telephone customer self-help, voice control of simple devices such as in GPS navigation, and in large vocabulary enrolled-speaker transcription, such as IBM Via Voice® and Nuance Naturally Speaking®, the more general capability of unrestricted spoken language understanding remains beyond the known technical art. Important example applications not yet commercially feasible include spoken document retrieval (as might be applied in legal discovery), broadcast news classification, contextual advertising against audio and video content, and call center agent performance and compliance monitoring.

One aspect of the invention addresses these problems through a novel combination of prior art speech recognition extended to simultaneously recognize speech, topics, and/or criteria.

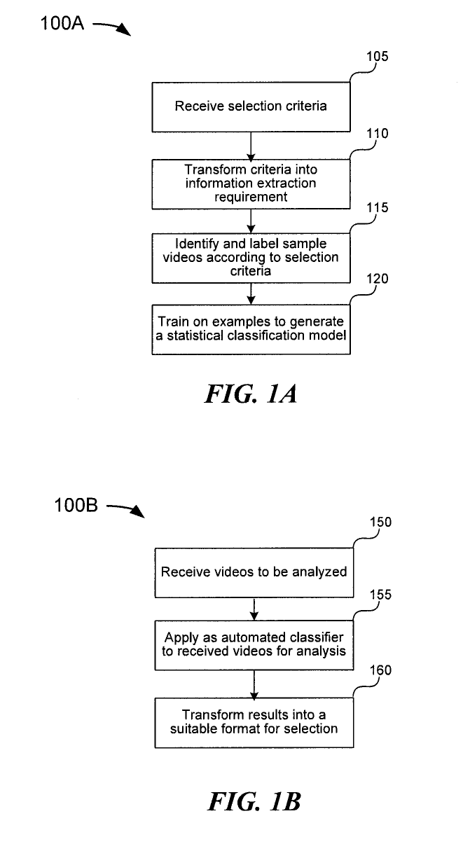

In one embodiment, well-known statistical machine learning algorithms are used to extract information from data. In one embodiment, these machine learning algorithms may be extended to provide information fusion with uncertain data, particularly as it relates to error-prone automated speech understanding. In the example of FIG. 1A, flow diagram 100A illustrates a top-down hypothesis evaluation technique for generating one or more statistical classification models derived from targeting objectives and/or selection criteria. The technique consolidates speech and topic/criterion recognition into a single optimization process, rather than using two separate and independent processes. This approach leads to a number of important advantages. The invention does not employ a grammar model, and thus does not require training on sample speech. This stands in contrast to current-art approaches based on statistical language models requiring thousands of hours of manually annotated, time-aligned labeled training data. Similarly, by not depending on a grammar—specific word and word sequence preferences, the technique retains accuracy across a broad range of topics and speakers. Perhaps the most important advantage, described in more detail below, is that a top-down topic recognition approach, where individual words are recognized only in context of each candidate topic hypothesis, yields greater accuracy than two-step approaches that first transcribe speech, and then recognize topic based on the (generally error-prone) transcription. The top-down topic/criterion recognition approach advantageously routes the targeted digital medium being evaluated based upon a cascading series of models. For example, videos can initially be confidently identified as belonging to a broad topic or criterion set (e.g. consumer electronics) before being routed to a more granular model (e.g. smartphones). By pre-sorting a video to a broad topic or criterion set before routing the video to a more granular topic or criterion model, the accuracy of the granular classification is increased and allows for more specific categorization of the video than would otherwise be possible using a single-model approach, for example, where ‘low confidence’ terms (e.g. apple, phone) cannot be safely leveraged. The invention identifies topic or criterion from a plurality of possibly very low-confidence word recognition results combined through a statistical process; intuitively, this is similar to a human's ability to sense context in speech from a few partially identified words, and thereafter apply a ‘context filter’ to enable or improve their overall understanding.

While the technology described below regarding spoken topic understanding applies to advertising as well as non-advertising applications, for clarity, advertising applications will be specifically described below. At block 105, the system receives targeting objectives and/or selection criteria. For advertising applications, in addition to providing audience-targeting objectives, advertisers also provide to the system characteristics of the video corpus against which they would like to advertise. Audience-targeting objectives include, but are not limited to, particular viewer demographics such as gender and age group, one or more topics and/or criteria and/or keywords, viewer interests, brand name references, a consumer's state within the buying process, if relevant, and other information that selects an appropriate advertisement opportunity. Audience criteria can be collected from a single advertiser, or from a community of advertisers with similar interests.

At block 110, the system transforms the information received from the advertiser at block 105 into information extraction requirements. Transformation can be explicit, whereby an advertiser specifies the concepts against which they desire to place advertisements (for example, Toyota requesting ad placement on auto review videos); or implicit, whereby the advertiser specifies a consumer demographic, consumer intent, or other specification once-removed from the video content (for example, Sony requesting ad placement on 12 to 25 year-old males). Alternatively or additionally, a controlled taxonomy of topics and/or criteria can be made available to advertisers that reflect topical areas of potential interest as well as groups of topics/criteria associated with a consumer demographic.

An explicit transformation may begin with advertiser-specified keywords. In one very simple example, an advertiser may place an ad-buy order for videos containing the words “auto” or “car”. Continuing with this example, it is noted that not all automotive videos contain those exact terms, but may instead refer to ‘sedan’ or ‘SUV’. To address this issue, the search terms may be extended to include words or phrases with semantically related meaning through use of language analysis tools, such as WORDNET (http://wordnet.princeton.edu/). Search terms can also be inferred through other methods. For example, proprietary and publicly available ontologies or structured data sources can be leveraged to extend the set of possible search term candidates by providing sets of related concepts of a given type, and in many cases, more specific and better-formed concepts can be provided. Inference on a data set such as Freebase or DBpedia can generate, for example, a list of known convertibles (e.g. Volkswagen Cabriolet, Chrysler Sebring) or a list of companies that manufacture a given product type (e.g. smartphone manufacturers: Apple, Motorola, Research in Motion, Google Android, etc.) Thus, candidate terms can be generated that are less ambiguous and can also perform better in phonetic analysis of search terms.

Topic modeling tools, such as Latent Semantic Analysis (U.S. Pat. No. 4,839,853) can further extend the explicit approach. LSA algorithms determine the relationships between a collection of digital documents and the language terms they contain, resulting in a set of ‘concepts’ that relate documents and terms. In practice, concepts prove superior to keywords in that that they provide a more accurate and robust means for identifying related information. In combination with inference on a reliable ontology, as described above, an LSA technique can be used to further abstract the notion of ‘concept’ to include not only explicit sets of keywords form a corpus but words that can be safely determined to impart the same meaning in the context of the video. Thus, the relative weight of a known instance of a convertible, such as Volkswagen Cabriolet, can be safely associated with other known instances of convertibles derived from the ontology, such as Chrysler Sebring. In one embodiment, the LSA technique can map advertiser-specified keywords into concepts; those concepts can then be used to identify example videos that meet an advertiser's objectives, and then used either directly, or to train statistical classification models (as in FIG. 1A, block 115, described below).

An implicit transformation begins with demographic and/or behavioral specifications. In one embodiment, visitors to a website are identified, such as through user login (often hidden, such as on nytimes.com), and monitored for video viewing behavior. The videos are then analyzed through techniques such as LSA (as described above) to identify conceptual links between consumer demographic and video content. In a related technique, video content located on websites with known demographic are collected and analyzed (for example, the break.com video sharing and publication site may be known for its 18-25 male demographic). Alternatively, brand-image sensitive advertisers may provide sample content—videos and/or text—that they believe appropriate to their marketing theme. For example, a youth-oriented consumer brand wishing to portray an active image may provide samples containing X Games events or other ‘action videos’ aimed at youthful audiences. Those samples are then either directly fed into the criterion modeling step of block 120, or, preferably, processed to identify salient common features from which a larger training corpus can be identified (for example, in block 115). In one embodiment, leveraging a controlled set of topics and/or criteria in a structured taxonomy can be safely associated with a target demographic. In this case, the amount of model development across disparate customers can be reduced, with the added benefit of providing the ability to infer demographic characteristics for clients without prior knowledge of their demographic mix.

In one embodiment, at block 115, sample videos may be identified and labeled according to the selection criteria for training purposes. In one embodiment, the system performs this step. Alternatively, a person can review the sample videos and store the information for the system to use. Other features such as viewer behavior can also be included if viewer time history information is available using behavioral targeting methods. In one embodiment, videos may be transcribed or processed through speech recognition as described below. In one embodiment, associated speech and text, such as editorial text surrounding a video on a publisher website, or comments in the form of a blog or other informal description may also be combined with the source video to provide additional training information.

At block 120, the system may train on the known video samples to generate one or more statistical classification models. The training process selects words and phrases taking into account a combination of topic/criteria uniqueness, phonetic uniqueness, and acoustic detectability. The process directly combines statistical models for acoustics, topics/criteria, and optionally word order and distance within a single mathematical framework. Phonetic and acoustic factors extend conventional topic analysis methods to improve performance on evaluating speech. Consequently, words and phrases sounding similar to common or out-of-topic words and phrases are eliminated or deemphasized in favor of distinctive terms. Similarly, soft words and short words are also deemphasized. In practice, the system prefers words with strongly voiced phonemes (“Beaverton”), and longer words and phrases (“6-speed transmission”, “New Hampshire presidential campaign”). Short words, homonyms, and terms ambiguous except for subtle, unvoiced variations provide less information, and are typically ignored. There is extensive prior art for applying machine learning-based categorization on text material, for example: T. Joachims, “Text categorization with support vector machines: learning with many relevant features”, in: C. Nedellec, C. Rouveirol (eds.), Proceedings of ECML-98, 10th European Conference on Machine Learning, Springer Verlag, Heidelberg, Del., Chemnitz, Del., 1998, available over the Internet at: http://citeseer.ist.psu.edu/joachims97text.html.

In accordance with one embodiment, N-gram frequency analysis is used to identify words and word sequences characteristic of videos fitting advertiser interest. Words and phrases are not detected in the standard meaning of 1-best transcription, or even in multiple hypothesis approaches such as n-best or word lattices. Instead, the underlying speech algorithm produces a time-sampled probability function for each search word or phrase that may be described as “word sensing.” Thus, phoneme sequences are jointly determined with the topics or criterion they comprise. In one embodiment, weighting of candidate terms used in phonetic-based queries for topic or criterion identification can be used to rate the suitability of the terms, either quantitatively or qualitatively. Language models involving sentence structure and/or associated adjacent word sequence probabilities are not required.

In contrast, conventional Large-Vocabulary Continuous Speech Recognition LVCSR approaches determine the most likely (1-best) or set of alternative likely (n-best or word lattice) phoneme sequences through a sentence-level optimization procedure that incorporates both acoustic and language models. With LVCSR approaches, acoustic models compare the audio against expected word pronunciations, while the language models predict word sequence chains according to either a rule-based grammar, or more commonly n-gram word sequence models. For each spoken utterance, the most likely sentence is determined according to a weighted fit against both the acoustic and language models. An efficient procedure, often based on a dynamic programming algorithm, carries out the required joint optimization process.

In accordance with one embodiment, after identifying words and word sequences fitting an advertiser's interest, statistical topic/criterion models are generated that weigh and combine terms to generate a composite score. Topics and/or criterion are identified by the aggregate probability of non-overlapping words and phrases that distinguish a topic or criterion from other topics or criteria. In one embodiment, a dynamic programming algorithm identifies the non-overlapping set of terms that optimize the joint probability for that topic/criterion across a desired time window or over the entire video (e.g., for short clips). These probabilities are compared across the set of competing topics/criteria to select the most probable topics/criteria. The joint probability function can be based on support vector machines (SVM) and/or other well-known classification methods. Further, word and phrase order and time separation preferences may be included in the topic/criterion model. A modified form of statistical language modeling generates prior probabilities for word order and separation, and the topic/criterion analysis algorithm includes these probabilities within the term selection step described above. Then the results of the statistical model may be experimentally validated on a different set of videos.

Training of the system may not be necessary for every digital media evaluation based on an advertiser's criteria. For example, two advertiser's criteria may be similar so that a classification model derived for one advertiser may be re-used or modified slightly for the second advertiser. Alternatively, a controlled hierarchical taxonomy can be leveraged that provides ‘canned’ options to meet multiple customers' needs as well as a structure from which model-definition can occur. The benefits of model definition on a known taxonomy include, but are not limited to, the ability to generate models for categories that may not be relevant to any advertiser but which provide information that can be leveraged when the system makes final decisions about a given video's topical coverage. For example, a model trained on the fruit ‘apple’ can be leveraged to disambiguate videos about smartphones from videos that are more likely about something else.

Once the statistical topic and/or criterion models are generated, they may be applied by the system to other digital media. In the example of FIG. 1B, flow diagram 100B illustrates a technique for applying the models. At block 150, the system receives one or more videos and/or digital media to be analyzed. The digital media may be stored on a server or in a database and marked for analysis.

At block 155, the statistical classification model generated at block 120 above is applied to automatically classify the digital media to be analyzed.

Additional category-dependent information may also be extracted as required. Once a piece of digital media is associated with a topic or criterion model, additional terms such as named entities or other topic/criterion-related references may be extracted through a phonetic recognition process or more conventional transcription automatic speech recognition (ASR) because these processes may be more accurate within the narrower vocabulary associated with the topic or criterion model. For example, on automotive topics, the system may seek words and phrases such as “Mercury”, “Mercedes Benz”, or “all-wheel drive”, all of which have specific meaning within context yet, in practice, prove difficult to recognize without contextual guidance. The top-down multiple model approach to video categorization described above allows for more specific vocabulary to be introduced as videos are ‘routed’ to ever more specific models. The same ‘routing’ can also be based on explicit metadata associated with the video (e.g. sports vs. travel section of a website) or simple manual categorization into broad topic areas. Inference on a reliable ontology, as described above, can provide the narrow vocabulary required to handle very specific topics, allowing for vocabulary sets to be developed even in cases where no training corpus is available and for which candidate vocabularies change quickly over time.

At block 160, the system transforms the results from block 155 into a format suitable for selection and placement. In one embodiment, an advertisement server would be used for advertising selection and placement. The transformation may include performing speech processing using an aggregate collection of search terms to produce a time-ordered set of candidate detections with associated probabilities or confidence levels and offset times into the running of the digital media. It should be noted that the confidence threshold may be set very low because the probabilistic modeling assures that the evidence has been appropriately weighted.

In one embodiment, the transformation applies statistical language models to match content to advertiser interests. Some advertisers may share similar, although not identical interests. In this case, existing recognition models may be extended and re-used. For example, an aggregated collection of digital media may be updated to identify new terms and/or create an additional topic/criterion model. In one embodiment, the additional topic/criterion model would be a mixture and/or subtopic of existing models.

In one embodiment, new search terms may be placed in a queue and periodically reviewed in light of other new topic or criterion requests from advertisers. If the original topic or criterion set is broad, new search terms will not often be required, and they may be generally nonessential because other factors, such as sound quality of the digital media, may prove more important in determining topic or criterion identification performance.

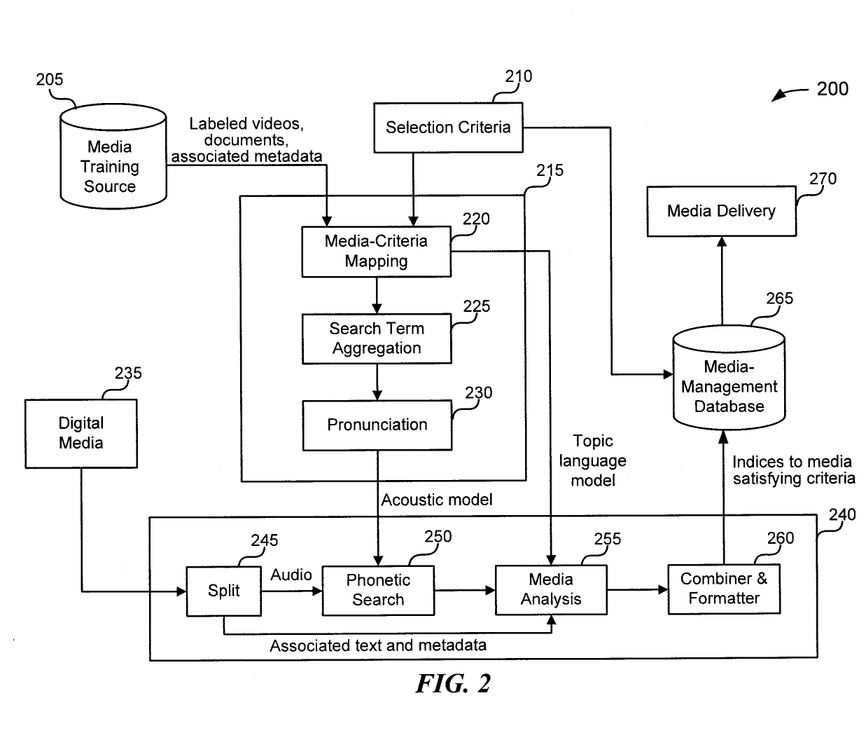

In the example of FIG. 2, block diagram 200 illustrates an example of a generic application system for spoken topic or criterion recognition of online digital media, according to one embodiment. The system includes a media training source module 205, selection criteria 210, a trainer module 215, an analyzer module 240, digital media module 235, a media management database 265, and media delivery module 270.

The media training source module 205 provides labeled videos and documents and associated metadata to the trainer module 215. The media training source module 205 obtains training data from sources including, but not limited to, a publisher's archive, standard corpus accessible by an operator of the invention, and/or results from web crawling. The media training source module 205 delivers the data to the media-criteria mapping module 220 in the trainer module 215.

The selection criteria module 210 requests and receives selection criteria from users who have applications that use spoken topic/criterion understanding of digital media. Selection criteria include, but are not limited to, topics, names, and places. The selection criteria 210 are sent to the media-criteria mapping module 220 in the trainer module 215.

For an advertising application, the selection criteria may relate to advertiser placement criteria objectives obtained. Module 210 obtains placement criteria from advertisers. Advertisers specify the placement criteria such that their advertisements are placed with the appropriate digital media audience. Placement criteria include, but are not limited to, topics, names of products, names of people, places, items of commercial interest, targeted demographic, targeted viewer intent, and financial costs and benefits related to advertising. Advertisers may also specify placement criteria for types of digital media that their advertisements should not be placed with.

The trainer module 215 generates one or more statistical classification models based upon training samples provided by the media training source 205. One of the outputs of the trainer module 215 is an acoustic model expressing pronunciations of the words and phrases determined to have a bearing on the topic/criterion recognition process. This acoustic model is sent to the phonetic search module 250 in the analyzer module 240. The trainer module 215 also generates and sends a topic/criterion language model to the media analysis module 255 in the analyzer module 240. The topic/criterion model expresses the probabilities on words, phrases, their combinations, order, and time difference, along with, optionally, other language patterns containing information tied to the topic/criterion. The trainer module 215 includes a media-criteria mapping module 220, a search term aggregation module 225, and a pronunciation module 230.

The media-criteria mapping module 220 may be any combination of software agents and/or hardware modules for transforming the selection criteria into information extraction requirements and identifying and labeling sample videos according to a application's objectives; associated metadata and other descriptive text may be processed as well. A minimum set of terms (words or phrases) necessary to distinguish target categories are identified, along with a statistical language model of the topic or criterion. In one embodiment, the topic/criterion model comprises a collection of topic features and associated weighting vector produced by support vector machine (SVM) algorithm. For an advertising application, the media-criteria mapping module 220 can be replaced by a media-advertisement mapping module 220, where the digital media are mapped to an advertiser's objectives, as specified by advertiser placement criteria in module 210.

The search term aggregation module 225 may be any combination of software agents and/or hardware modules for collecting search terms across all topics or criteria of interest. This module improves system efficiency by eliminating redundant term processing, including redundant words, as well as re-using partial recognition results (for example, the “united” in “united airlines” and “united nations”) Such a system can leverage external sources to derive candidate terms that are not explicit in a training set.

Inference, as described above, can be used as a means for ‘bootstrapping’ the training/model development by generating candidate terms. For example, assume that terms in a class, such as smartphones, could be treated in the same manner in order to account for the lack of a mention of a given candidate term in the set of terms used to establish initial thresholds. In text classification, this can be done with parts of speech or given entity types, where a person's name, as a class of entity, is given more or less weight based on the fact that it is a person, and not because it is a specific person. Then including sets of known terms (for example, auto models) that meet some other criteria can make the system more universally applicable to previously unseen data sets. Criteria that the known sets can meet include length or some automatically derived notion of uniqueness such that there is a way to distinguish between a good term and a bad term.

The pronunciation module 230 converts words into phonetic representation, and may include a standard pronunciation dictionary, a custom dictionary for uncommon terms, and an auto pronunciation generator such as found in text-to-speech algorithms.

A digital media module 235 provides digital media to the analyzer module 240. The digital media module 235 may be any combination of software agents and/or hardware modules for storing and delivering published media. The published digital media includes, but is not limited to, videos, radio, podcasts, and recorded telephone calls.

The analyzer module 240 applies statistical classification models developed by the trainer module 215 to digital media. By using the top-down hypothesis evaluation technique for generating the classification models, accurate classification can be achieved. The outputs of the analyzer module 240 are indices to digital media that satisfy the selection criteria 210. The analyzer module 240 includes a split module 245, a phonetic search module 250, a media analysis module 255, and a combiner and formatter module 260.

The split module 245 splits the digital media obtained from the digital media module 235 into an audio stream and the associated text and metadata. The audio stream is sent to the phonetic search module 250 which may be any combination of software agents and/or hardware modules that search for phonetic sequences based upon the acoustic model provided by the trainer module 215.

The phonetic search results from phonetic search module 250 are sent along with the associated text and metadata for a piece of digital media from the split module 245 to the media analysis module 255. The media analysis module 255 may be any combination of software agents and/or hardware modules that automatically classifies the digital media according to the topic/criterion model provided by the trainer module 215. The media analysis module 255 compares the combination of text, metadata, and phonetic search results associated with a media segment against the set of sought topic/criterion models received from the media-criteria mapping module 220. In one embodiment, all topics or criteria surpassing a preset threshold are accepted; in a separate embodiment, highest-scoring (most likely) topic or criterion exceeding a threshold is selected. Prior art in topic/criterion recognition cites a number of related approaches to principled analysis and acceptance of a topic/criterion identification.

The combiner and formatter module 260 may be any combination of software agents and/or hardware modules that accepts the topic/criterion analysis results of media analysis module 255 to produce the set of topic/criteria identifications with associated probabilities or confidence levels and offset times into the running of the digital media.

The media management database 265 stores selection criteria and the indices to the pieces of digital media that satisfy the selection criteria. For an advertising application, the media management database 265 stores advertiser placement criteria and the indices to the pieces of digital media that satisfy the advertiser's placement criteria.

The media delivery module 270 may be any combination of software agents and/or hardware modules for distributing, presenting, storing, or further analyzing selected digital media. For advertising applications, the media delivery module 270 can place advertisements with an identified piece of digital media, and/or at a specific time within the playing time of the digital media.

In one embodiment, one or more payment or transaction systems may be integrated with the above system, such that an advertiser pays a fee to the owner or publisher of the digital media. Authentication and automatic payment techniques may also be implemented.

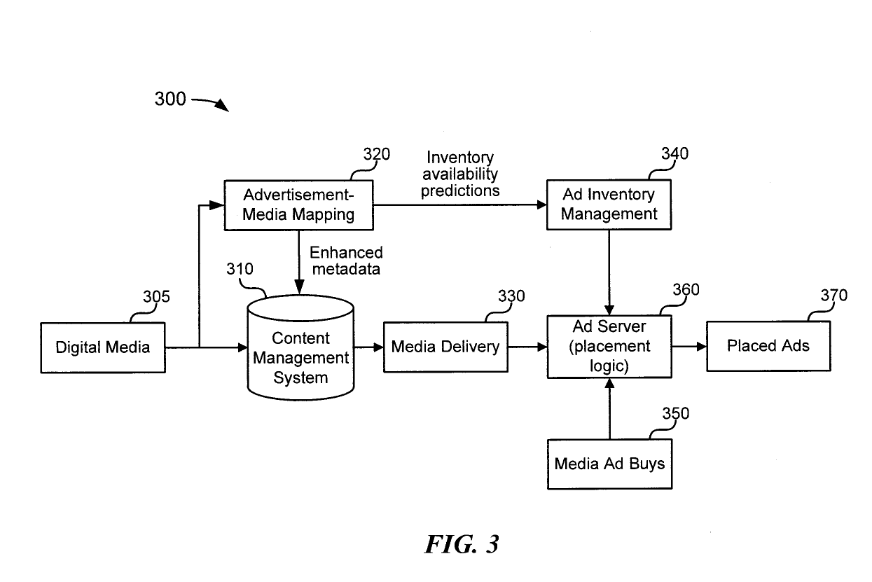

In the example of FIG. 3, block diagram 300 illustrates an example online digital media advertising system employing a contextual advertising for digital media application, according to one embodiment. The system includes a digital media source 305, a content management system 310, an advertisement-media mapping module 320, a media delivery module 330, an ad inventory management module 340, a media ad buys module 350, an ad server 360, and placed ads 370. More than one of each module may be used, however only one of each module is shown for clarity in FIG. 3.

The digital media source 305 provides digital media including, but not limited to, video, radio, and podcasts, that are published to a content management system 310 and an advertisement-media mapping module 320. The digital media source 300 may be any combination of servers, databases, and/or content publisher systems.

The content management system 310 may be any combination of software agents and/or hardware modules for storing, managing, editing, and publishing digital media content.

The advertisement-media mapping module 320 may be any combination of software agents and/or hardware modules for identifying topics and/or criterion and/or sentiments contained in the digital media provided by the digital media source 305 and for delivering the identified information to the content management system 310. In some embodiments, the metadata-media mapping information of the advertisement-media mapping module 320 is also provided to an ad inventory management module 340. The inventory management module 340 may be any combination of software agents and/or hardware modules that predict the availability of contextual ads by topic/criterion and sentiment in order to estimate the number of available advertising opportunities for any particular topic or criterion, for example, “travel to Italy” or “fitness”.

The information provided by the inventory management module 340 is provided to the ad server module 360. The ad server module 360 may be any combination of software agents and/or hardware modules for storing ads used in online marketing, associating advertisements with appropriate pieces of digital media, and providing the advertisements to the publishers of the digital media for delivering the ads to website visitors. In one embodiment, the ad server module 360 targets ads or content to different users and reports impressions, clicks, and interaction metrics. In one embodiment, the ad server module 360 may include or be able to access a user profile database that provides consumer behavior models.

The content management system 310 delivers digital media through a media delivery module 330 to the ad server 360. The ad server 360 may be any combination of software agents and/or hardware modules for associating advertisements with appropriate pieces of digital media and providing the advertisements to the publishers of the digital media. In one embodiment, the ad server 360 can be provided by a publisher.

The media ad buys module 350 receives information from advertisers regarding criteria for purchasing advertisement space. The media ad buys module 350 may be any combination of software agents and/or hardware modules for evaluating factors such as pricing rates and demographics relating to the advertiser's objectives. The ad buys module 250 provides advertiser's requirements to the ad server module 360.

The placed ads 370 are the advertisements that are selected for placement by the ad server module 360 which takes into account input from the advertisement-media mapping module 320, the ad inventory management module 340, and the media ad buys module 360. The placed ads 370 meet advertiser's placement criteria and are displayed in association with appropriate digital media as determined by the advertisement-media mapping module 320. In one embodiment, advertisements are displayed only at certain times during the playing of digital media.

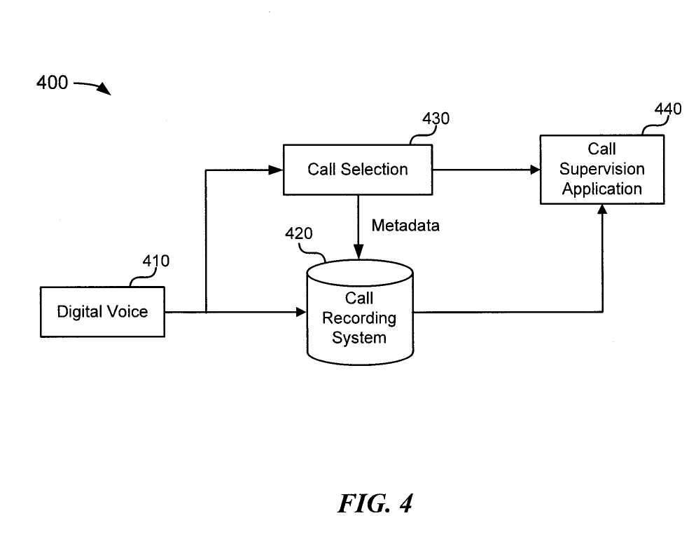

In the example of FIG. 4, a block diagram is shown for a system 400 for automated call monitoring and analytics, according to one embodiment. The system includes a digital voice source 410, a call recording system 420, a call selection module 430, and a call supervision application 440.

The digital voice source 410 provides a stream of digitized voice signals, as may be found in a customer services call center or other source of digitized conversations, and optionally stored in the call recording system 420. The call recording system 420 may be any combination of software agents and/or hardware modules for recording telephone calls, whether wired or wireless.

The call selection module 430 may be any combination of software agents and/or hardware modules for comparing digital voice streams to selection criteria. The call selection module 420 forwards indices of voice streams matching the selection criteria to speech analytics and supervision applications module 440.

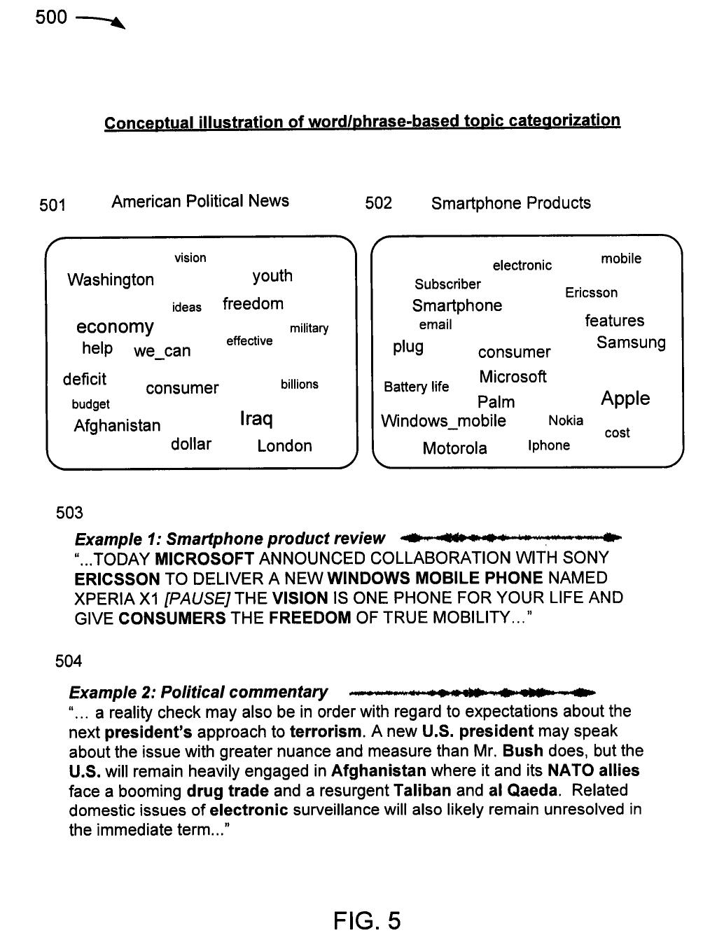

In the example of FIG. 5, conceptual illustration 500 of word and/or phrase-based topic/criterion categorization is shown, according to one embodiment. This simplified diagram represents topic/criterion models 501 “American Political News” and 502 “Smartphone Products” as “bags of words” (and phrases) commonly found within each topic or criterion, with font size indicating utility of term in determining the topic/criterion. For this example, “economy” and “Iraq” are powerful determinants for recognizing 501 “American Political News”. Two sample media transcriptions 503, 504 are shown. Sample 503 is a smartphone product review, and sample 504 is political commentary. Each sample contains words that are unique to each topic/criterion and words that are common to both. The topic/criterion identification process, therefore, views each media sample as a whole, collecting evidence for both models, weighting words and word combinations according to all topic/criterion models, and making a decision from the preponderance of information over a period of time.

Unlike its text analysis brethren, spoken topic/criterion recognition systems must contend with highly imperfect inputs. Speech recognition systems miss some words, hallucinate others, and misrecognize yet more. To emphasize this point with a real-world example, here are the results of a best-in-class commercial, speaker-trained transcription system operating on audio from a high-quality, close-talking, microphone in a quiet setting:

Accurate Transcription (Manually Created Reference)

Oct. 14, 2007. On a recent Saturday night, an invitation-only dance party was in full swing at Asia Latina.

Automatically Recognized Speech

Over 42,007. Reese's are denied invitation-only dance party was in full swing and usual Latina.

Although anecdotal, these results are representative of speech recognition operating under favorable acoustic conditions. In contrast, speech recognition systems that operate on lower-quality audio, such as highly compressed speech, audio collected from a poor microphone source, audio with background noise, or speech of accented speakers, produce much worse results, typically achieving no more than 10-20% word accuracy. This low level of performance creates a very practical limitation for subsequent topic/criterion analysis.

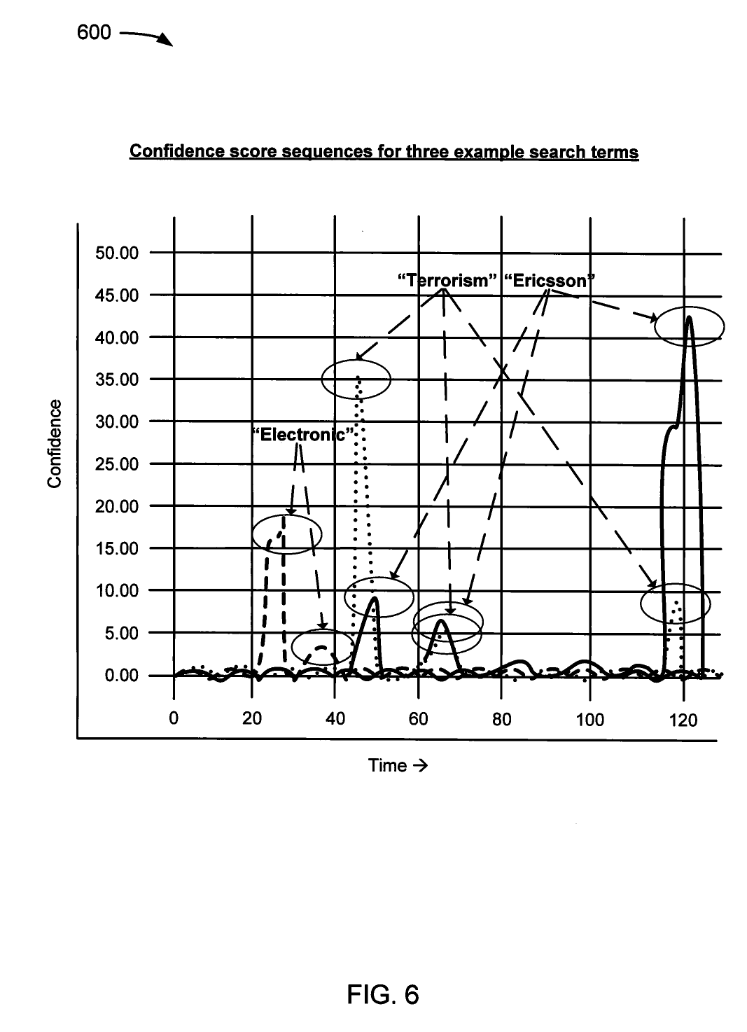

In the example of FIG. 6, confidence score sequences for three example search terms taken from the topic/criterion models in FIG. 5 are shown, according to one embodiment. The horizontal axis represents time (00's of speech frames), while the vertical axis represents probability or confidence. The probability of three example search terms, “electronic”, “terrorism”, and “Ericsson” are plotted as a function of the term's start time (for simplicity the term length, which varies with speaker, is not shown). A time-sampled probability value is produced for each search term over the observation period. Peaks indicate most likely start times for each term. Words containing similar sounds produce correspondingly similar probability functions (cf “terrorism” and “Ericsson”). Note that, in keeping with the inherent frailty of speech recognition technology, the correct term may not always produce the highest probability. To address this issue, the invention includes a method for combining a large number of low-confidence topic/criterion terms within a principled mathematical framework. To support this, the phonetic search module 250 of FIG. 2 produces the set of all search terms exceeding a low threshold, along with corresponding detection times. In one embodiment, search term detections correspond to probability peaks, as exemplified in FIG. 6. The search term detections are then weighted according to their probability and combined through the topic/criterion recognition function within media analysis module 255. In this way, alternative term detections can be simultaneously considered within the topic/criterion analysis process. This “soft” detection approach enables the invention to correctly identify topics or criteria under adverse conditions, and in the extreme, where none of its individual terms would be recognized under conventional speech recognition technology.

Recognizing an Audience by Videos Watched and Published

Most advertisers do not have a direct interest in the actual content of a video; rather, they seek to reach a selected demographic in a particular state of mind or with a particular intent. For example, Google famously recognizes and monetizes consumer intent through search term analysis, and to that Amazon adds an analysis of their customer's long-term buying behavior. Publishers craft their websites to attract a desired demographic profile. For example, break.com specializes in videos demonstrating sophomoric male behavior for a target male audience in the age range 24-35, while Martha Stewart and Home & Garden offer wholesome, commercially motivated how-to videos for a target college-educated female audience in the age range 40-55. A user's arrival at one of these websites is sufficient to determine that particular user's demographic and interests.

However, with digital media hosted on a website that appeals to a broader audience, it is not as easy to determine a user's profile. One common solution, for example as deployed by YouTube, involves term expansion (through Google-search) applied to a video's metadata, primarily the short description provided by the consumer/publisher. This works well if the originator of the video takes the time to create an accurate, unambiguous description, such as ‘singer plus song title’. Some videos require more work to describe, however, and consumers infrequently make the necessary effort. Other descriptions are intended to be humorous, ironic, or as commentary, and do not provide a useful summary.

Yet video content provides important clues about a viewer's age, education, economic status, health, marital status and personal interests, whether or not the video has been carefully labeled and categorized, whether manually or automatically using technology. Easily observed factors include, but are not limited to, the pace of speech, the speaker's gender, number of speakers, the talk duty cycle, music presence or absence along with rudimentary music structure, and indoor versus outdoor site. This information can be extended through relatively simple speech recognition approaches to, for example, pick up on diction, named entities, word patterns and coarse topic/criterion identification.

In an extension to the topic/criterion analysis platform described above, a machine-learning framework may be established to train a system at block 120 above to classify demographic and intent, rather than details about the topic/criterion. Alternatively, a taxonomy developed to meet the needs of advertiser can be leveraged to place videos into demographic sets by associating groups of topics or criteria from the taxonomy with known demographic sets, as appropriate. For example, topics addressing infant care, childbirth, etc. can be associated with a ‘new parents’ demographic.

Advertisement Value Maximization Through Reward Versus Risk Optimization Accounting for Natural Speech Understanding Technology

As described above, an advertiser specifies requirements such as demographic, viewer interests, brand name references, or other information for selecting an appropriate advertisement opportunity. In one embodiment, a set of recognition templates is generated from these requirements, and applied to various digital media for determining advertisement opportunities. In a preferred embodiment, these templates may consist of topics or concepts of interest to the advertiser along with key phrases or words, such as brand names, locations, or people. The system then applies these templates to generate corresponding statistical language recognition models.

In one embodiment, these models are trained on sample data that have been previously labeled by topic/criterion or demographic. In general, however, any arbitrary data labeling criteria may be applied to the sample data. In one example of arbitrary labeling, toothpaste advertising performance can be empirically determined for a certain collection of digital media. This collection would provide a sample data set from which the system automatically learns to recognize ‘toothpasteness’, that is, through speech and linguistic analysis, identify other digital media content that will likely yield similar advertising opportunities for toothpaste.

In addition or alternatively, the system can identify instances where advertisers do not want to place an advertisement, for example, topics the advertisers believe to be offensive to their intended audience or otherwise inconsistent with their brand image.

Human language, and in particular conversational speech, is often ambiguous, inconsistent, and imprecise. Compounding this, automated speech recognition and language understanding technology remain imperfect because machines do not yet reach human abilities in dialog, and even humans often misunderstand other humans. To accommodate expected imperfections, the invention includes a facility for estimating system performance relative to advertiser specification in addition to conveniently tuning system behavior through modeling and experimentation.

Typical performance measures used with speech recognition or language understanding technology may include recall and precision. The recall measure is the fraction of digital media examples that a system can be expected to match with an advertiser's specifications, that is, the number of examples the system correctly found divided by the total number of examples known to be correct in the data set. The precision measure is the fraction of matches that are correct, that is the number of examples the system correctly found divided by the total number of examples found, both correct and incorrect. Although these measures are useful in understanding technical performance and are commonly reported in technical literature, they do not directly reflect business suitability of a particular system.

Additional measures of performance that may be of more interest to an advertiser would include calculating the financial benefits of accuracy and the financial cost of errors. On the benefits side, accurately matching a viewer's interest with an advertising opportunity creates a quantifiable increase in value to an advertiser. This benefit is often measured in terms of CPM price (cost per thousand viewer impressions), “click-through” rates (cost per viewer taking action on an advertisement, such as selecting a link to view a larger advertisement or sales site), or the sales revenue increase due to the advertisement.

The cost of a mistake varies by its severity. In a first example, confusing viewer interest in convertibles versus sedans would not likely prove offensive to a viewer nor harmful to the reputation of an automaker that may select an advertisement for a convertible when a sedan may have been more appropriate. This would be a low-severity error, although the error may reduce the benefit, as discussed above. In a second example, mistaking interest in children's literature with interest in explicit song lyrics would be more severe, perhaps especially for the advertiser of childhood storybooks. In these examples we see that the cost of advertising placement errors depends on a number of social and business factors. Moreover, the cost of these errors is not necessarily equal across advertisers.

The financial benefits and costs of system performance may be directly incorporated into the speech and language modeling process, such that the system's model generation procedure considers not only standard measures of topic/criterion classification and word recognition performance, but also the financial consequences. The expected system performance is presented to an end user, such as personnel with advertising placement responsibilities. The performance measures may include, but are not necessarily limited to, standard measures such as recall and precision, severity-weighted error rates, and the number and character of expected errors. The user can then explore suitability of the available digital media content to their advertising needs, modify cost and benefit values, and otherwise explore options on advertisement placement.

Unless the context clearly requires otherwise, throughout the description and the claims, the words “comprise,” “comprising,” and the like are to be construed in an inclusive sense, as opposed to an exclusive or exhaustive sense; that is to say, in the sense of “including, but not limited to.” As used herein, the terms “connected,” “coupled,” or any variant thereof, means any connection or coupling, either direct or indirect, between two or more elements; the coupling of connection between the elements can be physical, logical, or a combination thereof. Additionally, the words “herein,” “above,” “below,” and words of similar import, when used in this application, shall refer to this application as a whole and not to any particular portions of this application. Where the context permits, words in the above Detailed Description using the singular or plural number may also include the plural or singular number respectively. The word “or,” in reference to a list of two or more items, covers all of the following interpretations of the word: any of the items in the list, all of the items in the list, and any combination of the items in the list.

The above detailed description of embodiments of the disclosure is not intended to be exhaustive or to limit the teachings to the precise form disclosed above. While specific embodiments of, and examples for, the disclosure are described above for illustrative purposes, various equivalent modifications are possible within the scope of the disclosure, as those skilled in the relevant art will recognize. For example, while processes or blocks are presented in a given order, alternative embodiments may perform routines having steps, or employ systems having blocks, in a different order, and some processes or blocks may be deleted, moved, added, subdivided, combined, and/or modified to provide alternative or subcombinations. Each of these processes or blocks may be implemented in a variety of different ways. Also, while processes or blocks are at times shown as being performed in series, these processes or blocks may instead be performed in parallel, or may be performed at different times. Further any specific numbers noted herein are only examples: alternative implementations may employ differing values or ranges.

The teachings of the disclosure provided herein can be applied to other systems, not necessarily the system described above. The elements and acts of the various embodiments described above can be combined to provide further embodiments.

While the above description describes certain embodiments of the disclosure, and describes the best mode contemplated, no matter how detailed the above appears in text, the teachings can be practiced in many ways. Details of the system may vary considerably in its implementation details, while still being encompassed by the subject matter disclosed herein. As noted above, particular terminology used when describing certain features or aspects of the disclosure should not be taken to imply that the terminology is being redefined herein to be restricted to any specific characteristics, features, or aspects of the disclosure with which that terminology is associated. In general, the terms used in the following claims should not be construed to limit the disclosure to the specific embodiments disclosed in the specification, unless the above Detailed Description section explicitly defines such terms. Accordingly, the actual scope of the disclosure encompasses not only the disclosed embodiments, but also all equivalent ways of practicing or implementing the disclosure under the claims.

What is claimed is:

1. A method of targeting one or more digital media for a spoken topic understanding application, comprising:
receiving one or more selection criteria;
performing a top-down criterion recognition of the digital media using the selection criteria as a starting point;
recognizing spoken words in the digital media in context of each selection criteria; and
identifying a first set of the digital media relevant to the selection criteria.

2. The method of claim 1, wherein performing the top-down criterion recognition does not include transcribing of the digital media.

3. The method of claim 1, wherein the spoken topic understanding application is an advertising application.

4. The method of claim 1, wherein the spoken topic understanding application is a non-advertising application.

5. The method of claim 1, wherein performing the top-down criterion recognition of the digital media comprises:
generating a broad criterion set from the selection criteria and pre-sorting the one or more digital media to the broad criterion set;
generating candidate criterion hypotheses at a finer granularity by using topically or demographically relevant query terms;
classifying the one or more digital media at the finer granularity.

6. The method of claim 5, wherein topically or demographically relevant query terms are obtained using metadata or inference on proprietary or publicly available ontologies.

7. The method of claim 1, further comprising training on digital media examples to generate one or more classification models for use in performing the top-down criterion recognition of the digital media.

8. The method of claim 7, further comprising based upon a particular application for the spoken topic understanding, calculating and incorporating a financial benefit of accurate identifications and a financial cost of inaccurate identifications into the classification models.

9. The method of claim 1, wherein selection criteria include one or more of a group consisting essentially of one or more topics, one or more names of products, one or more names of people, one or more places, items of commercial interest, and financial costs and benefits related to applications for spoken topic understanding, and further wherein performing top-down criterion recognition of the digital media comprises transforming the selection criteria into a set of search terms that distinguishes target categories and using a time-sampled probability function for each search term.

10. The method of claim 1, wherein selection criteria includes one or more of a group consisting essentially of targeted demographic, targeted viewer intent, one or more names of products, one or more names of people, one or more places, items of commercial interest, and financial costs and benefits related to applications for spoken topic understanding, and further wherein performing top-down criterion recognition of the digital media comprises transforming the selection criteria into a set of search terms that distinguishes demographic and viewer intent.

11. The method of claim 1, wherein performing the top-down criterion recognition of the digital media further comprises evaluating metadata associated with the digital media.

12. The method of claim 1, wherein performing the top-down criterion recognition of the digital media further comprises evaluating descriptive annotations associated with the digital media comprising on-line text descriptions, media source information, and information derived from other digital media processing technologies.

13. The method of claim 1, wherein performing the top-down criterion recognition of the digital media further comprises using computer speech recognition techniques and using natural language understanding techniques.

14. The method of claim 1, further comprising identifying a second set of the digital media for avoiding based upon a particular application for the spoken topic understanding.

15. A method of targeting one or more digital media for a spoken topic understanding advertising application, comprising:
receiving one or more advertising criteria;
generating a broad criterion set from the advertising criteria and pre-sorting the one or more digital media to the broad criterion set;
generating candidate criterion hypotheses at a finer granularity by using topically or demographically relevant query terms, wherein topically or demographically relevant query terms are obtained using metadata or inference on proprietary or publicly available ontologies;
classifying the one or more digital media at the finer granularity;
recognizing spoken words in the digital media in context of each advertising criteria; and
identifying a first set of the digital media for advertisement insertion.

16. The method of claim 15, further comprising identifying specific times within the first set of the digital media for advertisement placement.

17. The method of claim 15, further comprising integrating advertisement insertion information with advertisement servers.

18. The method of claim 15, further comprising integrating advertisement insertion information with advertising-serving platforms.

19. The method of claim 15, further comprising integrating advertisement insertion information with media buying consoles.

20. The method of claim 15, further comprising integrating advertisement insertion information with publisher advertisement management systems.

21. A system for targeting digital media based upon spoken criteria recognition of the digital media, comprising:
a communications module configured to receive one or more target criteria;
a model generation module configured to perform a top-down criterion recognition of the digital media using the target criteria as a starting point; and
an analyzer module configured to recognize spoken words in the digital media in context of each target criteria, wherein the system identifies a first set of the digital media relevant to the target criteria based upon the analysis.

22. The system of claim 21, further comprising a training database configured to store labeled digital media examples for training the system to generate classification models for use in performing the top-down criterion recognition of the digital media.

23. The system of claim 21 wherein the analyzer module does not transcribe one or more audio tracks associated with the digital media.

24. The system of claim 21, wherein performing the top-down criterion recognition of the digital media comprises:
generating a broad criterion set from the target criteria and pre-sorting the one or more digital media to the broad criterion set;
generating candidate criterion hypotheses at finer granularity by using topically or demographically relevant query terms;
classifying the one or more digital media at finer granularity.

25. The system of claim 21, further comprising a user profile database for storing information about user behavior and preferences.

26. The system of claim 21, further comprising one or more sources of digital media.

27. The system of claim 21, further comprising a media-management database for storing indices to particular ones of the digital media satisfying the target criteria.
